(19) United States
(12) Patent Application Publication
(10) Pub. No.: US 2013/0337881 A1
(43) Pub. Date: Dec. 19, 2013

(54) International internet paper currency scanning and placement

(71) Applicant: David Carroll, Pine Knot, KY (US)

(72) Inventor: David Carroll, Pine Knot, KY (US)

(21) Appl. No.: 13/507,199

(22) Filed: Jun. 13, 2012

(51) Int. Cl. G07F 17/32

(52) U.S. Cl. CPC G07F 17/329
USPC 463/17

(57) ABSTRACT

Subscribers to the website using an optical scanner or similar device, uploads the paper currency of their choice onto a predesigned form, images of the currency will be randomly selected and displayed on the website or, informing where to locate the selected winning currency. Mobile device subscribers will have a similar process for the website/internet and mobile devices. The website will also precopy paper currency, place the currency in commerce, foreign/domestic for the general public to locate to receive a prize. All subscribers will view prepaid advertisements before the announcements of winning currency, subscribers must follow the website to timely claim a prize once the winning currency is announced. There will be predesignated locations for claiming prizes, contestants must present the actual currency and identification to claim their prizes.

### CROSS REFERENCE TO RELATED APPLICATIONS

N/A

STATEMENT REGARDING FEDERALLY SPONSORED RESEARCH OR DEVELOPMENT

N/A

REFERENCE TO SEQUENCE LISTING, A TABLE, OR A, COMPUTER PROGRAM LISTING COMPACT DISC APPENDIX

N/A

### BACKGROUND OF THE INVENTION

The object of this invention is to be a primary source for a wide array of businesses, individuals(entities ETC.) to market their business, product or service, utilizing the website/invention's process as described herein, displaying their ads. This website will be a marketing business were as its main focus will be on ad content, its social media aspect will be secondary. It will be the website's goal to assure its clientele, world wide, that a multitude of potential customers, clients, voters and more will view their ads at one time.

This invention should be examined according to the, machine-or-transformation, test(MOT), due to its business method process-concept.(35 §101)

This invention is described by the applicant as the closest lawful example on internet gambling/sweepstake/lottery without any of the financial risk associated with gambling or the taking of chances. Currently United States law forbid Internet gambling [31§§5361-67], especially, across state lines, U.S. borders and sports betting. The playing of numbers are involved, however, no bets or wagers are placed or required. Winning numbers will be announced and prizes-monetary and other things of value-will be awarded. The winning numbers will be randomly selected from the numbers placed on the website by the subscribers to the website, in the manner described below.

Internet gambling is forbidden for several reasons, from cheating to addiction, while some individuals refuse to gamble for religious and moral reasons. This invention eliminates all of the above reasons, which should encourage participation.

This invention also address the difficulties current websites are experiencing in obtaining or increasing, revenue from ad content. The subscribers to the website will view ads at no cost or risk to the subscriber, nor any cost in subscribing to the website. The ads will be placed and paid for by the business or entity that places the ad. The revenue raised from the placement of ads will be used to pay the winner or winners, that submitted their selected paper currency on the website's YLAD (pronounced i-lad) redeeming form. The numbers on the paper currency will be the numbers that are randomly selected for awarding prizes.

This ‘business method’ garners all the hype and intensity of gambling, without any risk, charge, bet or wager incurred by the subscribers to the website that will be placing numbers-via paper currency, and receiving winnings. Subscribers must regularly follow the website to learn what numbers are being announced and, in some cases, where the numbers will be announced.

The winning numbers will be announced during an ad or after an ad has been viewed. In some cases subscribers may be instructed to visit another website or location (i.e. TV, Radio, ETC) to learn of the numbers being announced.

In addition to subscribers scanning their chosen paper currency onto the website's YLAD redeeming form. This invention also include precopying paper currency to be strategically placed in the general public-foreign and domestic, commerce. The precopied paper currency then will be randomly selected for placing on the website announcing winning numbers. Any individuals in possession of the selected paper currency may claim a winning. If the possessor of the paper currency is not a subscriber to the website, they must first follow the process as described below for activating the YLAD and YLAP-P redeeming forms.

### SUMMARY OF THE INVENTION

This invention consist of subscribers to the website uploading his/her choice of paper currency on the website. This step achieved by scanning the paper currency and uploading it on the predesigned YLAD redeeming form. (A predetermined amount of copies will be suggested for downloading.) Once the required amount of YLAD forms are downloaded that portion of the site/page will automatically lock and cannot be reopened until the web master/site operator unlock it. The lock-out period is to deny access during the periods between the announcing of the winning numbers and the dead-line for collecting the winnings. Once the form is completed and downloaded, the YLAD redeeming form and the accompanying paper currency, should be stored in a safe place, each will be necessary to claim a winning. Typically, only one YLAD form will be entered per game, however, there will be certain occasions permitting a second application of the YLAD redeeming form.

As stated in the ‘Background’ this invention is intended to create revenue through ad content. To encourage subscribers to submit(play the numbers game) without facing a charge for entry into the game nor placing any bets or wagers, yet will be able to win money or other things of value.

The paper currency will be of the origin of the subscribers residency and scanned onto the website's YLAD redeeming form. And for the paper currency that was placed in the general public/commerce, the possessor of that winning currency will scan it onto the YLAD-P redeeming form. As stated earlier, as federal law currently stand internet gambling is largely forbidden and that applies to the states as well. This invention for the website is lawful and, induces the same thrill for subscribers as gambling induces without the risk of financial loss as gambling.

Due to the subscribers' anticipation of learning if their YLAD currency numbers are selected, this applicant expect the subscribers will anxiously monitor the website for the announcement of the randomly selected numbers.

Because the internet's reach is international every continent's residents will be able to upload their nation's paper currency on the website and monitor the website for announcements of the YLAD numbers with the same enthusiasm as just described above. The internet's world wide reach and the anticipated enthusiasm will assure that a substantial amount of people will be monitoring the website at one time guaranteeing that ads on display will be viewed by a substantial collection of people world wide. The effect of this collection of viewers to the website will attract advertisers to the website to reach this potential clientele, especially, the residents of all the industrialized nations.

Other than websites like ‘groupon’ most websites did not start-up with its main focus being on marketing or ad content. Most started with their main focus being on ‘social media’ ad content being secondary. This website/invention's main focus starts with marketing/ad content with ‘social media’ being secondary. The web-sites that started with their main focus on ‘social media’ are currently having difficulty in, obtaining or increasing, revenue through ad content, because no-one, before now, have invented a process assuring a stream of viewers to ads on display on internet sites/pages. This invention is intended to alleviate that problem.

This invention/website intends to sell ad display space at a rate similar to the rates for TV and radio in the United States market. This applicant think these rates are appropriate due to the fact that anyone wishing to take advantage of the U.S. market will have greater access to it in a single venue.

The website will be continuously monitored to determine how many subscribers are viewing the ads at one time during the announcements of the randomly selected number(s), averaging out the viewership to set a fee rate for placing an ad. the fee will always be adjusted to reflect viewership.

### DESCRIPTION OF THE INVENTION

This invention is intended to revolutionize marketing a product or service by way of the internet, assuring the website's customers a high concentration of viewership when displaying an ad on the website.

When subscribing to this website it will be mandatory for each subscriber to (1) Fill out a predesigned form. This form is currently being referred to as the YLAD redeeming form. (2) Once the mandatory portion of the YLAD redeeming form is completed, the subscriber will scan a single paper currency onto the YLAD form in the specially provided space. (3) next the subscriber will download a predetermined amount of copies of the completed form. Once the required amount of the YLAD redeeming forms are downloaded that portion of the page will automatically lock so no changes or access is available. (4) It will be suggested that the subscribers store the completed YLAD redeeming forms and the paper currency that was scanned on the form in a safe place.

The numbers on the paper currency will be the numbers that will be randomly selected for winnings, monetary or other things of value. (e.g. product or service)

If a subscriber's number is selected they will be required to present (A) Their YLAD redeeming form, (B) The matching paper currency, and (C) Their identification card, which is referred to as the YLAD redeeming package, to a predesignated location to redeem their predetermined winning. Only the subscriber that is both on the ID card and the YLAD redeeming form can claim a winning. The YLAD redeeming form and the YLAD paper currency will be retained by the designated locations making the payouts to the winners. The designated locations will be required to present or deliver the YLAD form and the paper currency to the operator of the website to be reimbursed for its payouts to the winning subscriber of the website.

In addition to the above invention, there will also be a YLAD-P redeeming form. This form (P=placement) is for the paper currency that will be strategically placed in commerce for the general public (domestic and foreign) to locate and determine if they are in possession of the winning numbers. These numbers will be randomly selected as well and, announced on the website. The paper currency will be precopied before placing in commerce. The YLAD-P redeeming form process will be the same steps as described for the YLAD redeeming form described above. The YLAD-P redeeming form and paper currency will also be retained by the company making the pay-outs.

No previous invention transform paper currency of all nations into a single uniform redeemable format. It does not matter what continent or country the paper currency originate it will be accepted at the designated locations, in which such locations will be operating world wide. Once the paper currency is scanned onto the YLAD and YLAD-P redeeming forms, the paper currency then is not just the currency of its origin, but also become YLAD currency and immediately is, potentially, worth more than its face value. Even if the paper currency is a Euro and that currency dissolve the YLAD currency will still have its potential and full value as determined by the website/invention. No other invention uniformly transform paper currency of all nations into a single currency and potentially increase the face value of the transformed currency. If the numbers on the subscribers' paper currency is selected no matter what nation the currency originated, its face value is automatically increased to its transformational value as determined by the website and redeemed according to the YLAD process.

Utilizing paper currency in which already have numbers printed on it will save the cost of printing coupons or similar redeemable articles, as well as distributing those articles through other outlets. The subscribers to the website, essentially, print their own redeemable article and, unlike traditional lotteries, raffles, sweepstakes, there is no betting, wagers or waiting in line for a clerk to place your numbers.

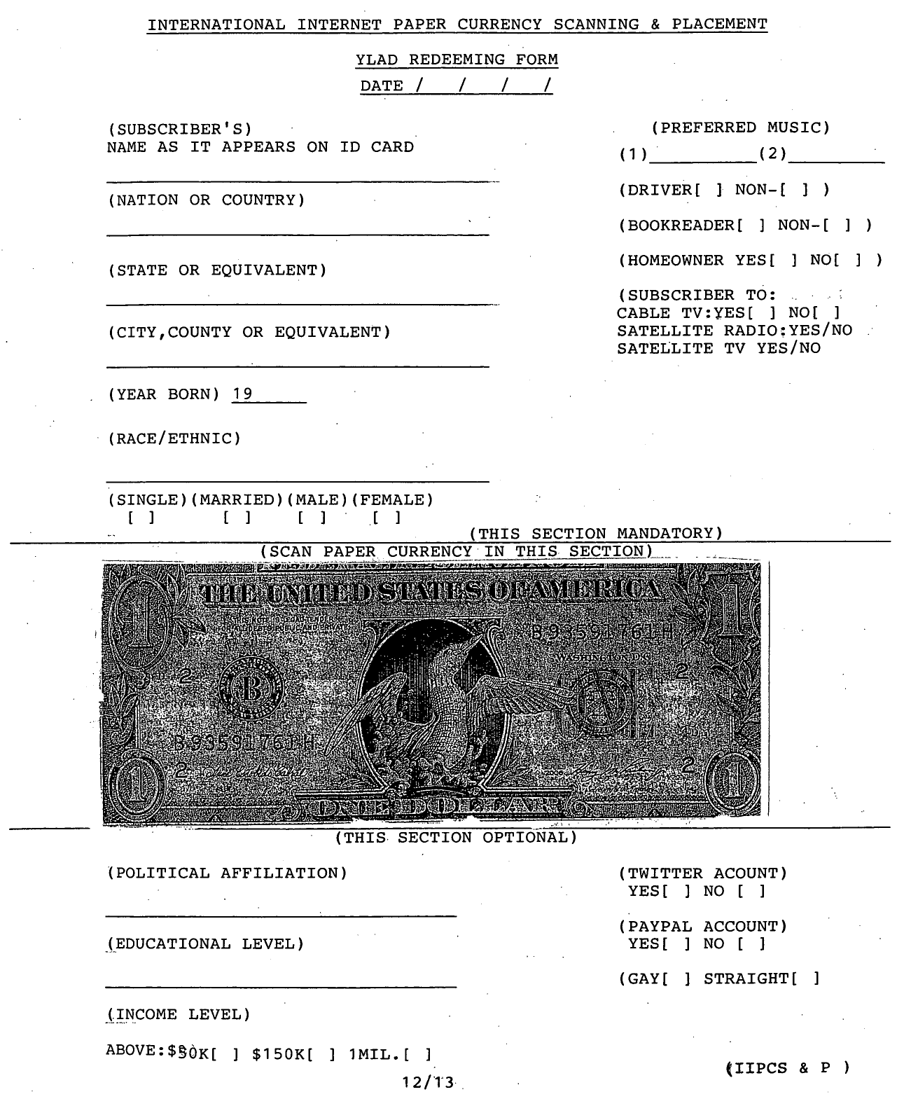

I. Applicant, seeks patent protection for his invention for the process and steps (1-9) as described below. His invention consist of the use of the internet, computers/monitors, cellular phones and the likes, scanners (type for scanning images) as tools for marketing businesses in the manner described below.
(1) The initial step for protection is, subscribers to the website will be scanning a single paper currency of their choice onto a predesigned form, currently being referred to as a, YLAD redeeming form. (see FIG. 1, page 12)
(2) The subscriber must fill out the mandatory portion of the YLAD redeeming form.
(3) Once the subscriber complete the YLAD form and scan their choice of paper currency onto it, they will then download a predetermined amount of copies of the YLAD form. It will be suggested that they store both the YLAD form and the paper currency in a safe place, they will need each article to claim a winning.
(4) The YLAD form section will automatically lock once the YLAD form is downloaded and will not unlock until the web master/site operator unlocks it.
(5) The numbers on the paper currency on each YLAD form will be the numbers randomly selected and announced for a subscriber to the website to follow to determine if they possess a winning number.
(6) The website will announce winning numbers on its website, and or, direct subscribers to a web page or other location (e.g. Radio, TV station, mobile phone, Etc.) to learn of the randomly selected winning number(s).
(7) To claim a winning, the winner will be instructed to present the YLAD redeeming package(YLAD form, paper currency ID card) to a predesignated vendor contracted with the website. The locations will be listed on the website.
(8) The predesignated vendors will retain the YLAD form and the paper currency. The vendors must submit the YLAD redeeming form and the paper currency along with its predesigned invoice to the website business to be reimbursed for the payouts to the winning subscribers(s).
(9) Businesses will pay the website to display their ads on the website where the randomly selected numbers will be announced. In some instances the businesses will pay the website to direct the subscribers to their preferred place or location to have the numbers announced their. The term ‘business’ when used applies to ads submitted by companies, organizations, clubs, clergy, any entity, public or private, governmental or non-governmental, as well as, individuals.
The applicant's request for patent protection also include patent infringement protection from the use of cellular and digital phones photographing paper currency and announcing winning numbers on mile site/phones, Etc.
The applicant's request for patent protection also include patent infringement protection in the use of paper currency numbers in any like or similar use as described above. Meaning that paper currency or its numbers should not be used to facilitate or enhance any game or business in the manner described above, or as described in claim II attached (page 11/13)

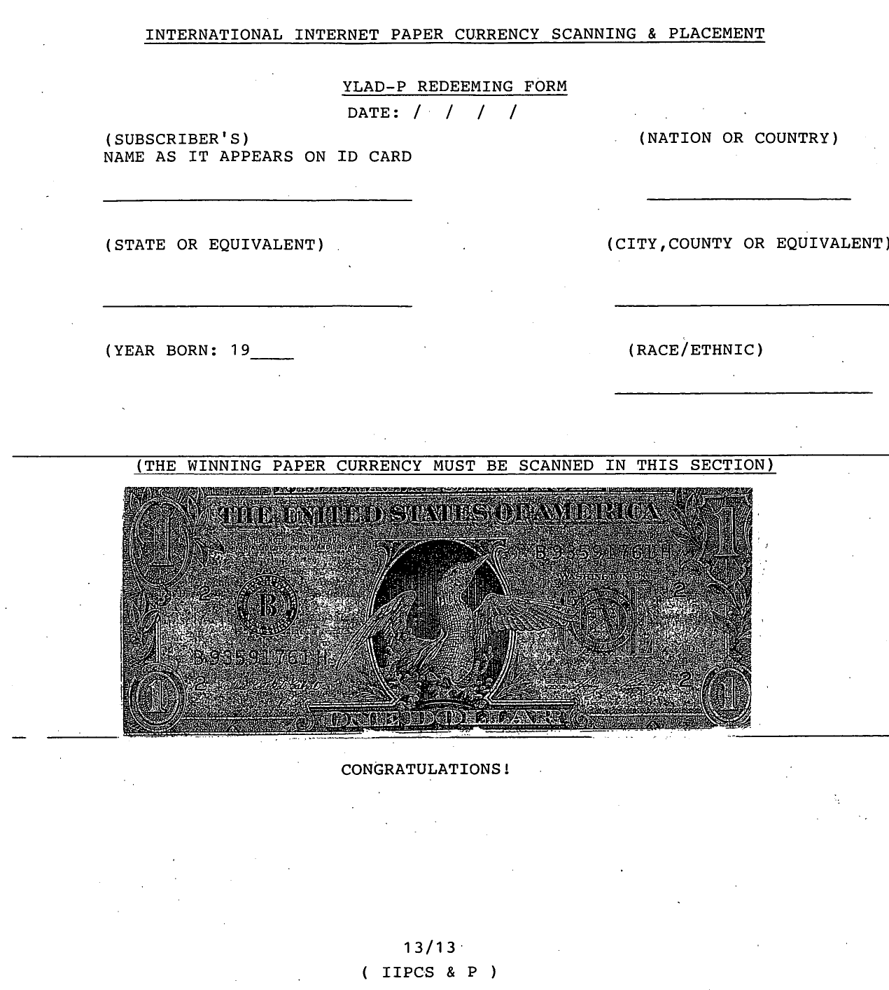

II. Applicant, seeks patent protection for his invention or the process and steps (1-6) as described below and in relation to claim I's of scanning paper currency onto the website's predesigned YLAD redeeming form and the pre-photographing of paper currency.
(1) Precopying paper currency, foreign and domestic.
(2) The precopied paper currency will be strategically placed in the general public/commerce.
(3) The website will randomly select from the precopied paper currency that will be placed in commerce, uploading a predetermined quantity of the copied paper currency for winning numbers to be announced from the selected copies.
(4) The subscribers, as well as, the general population, will log onto the website to se if they are in possession of the winning paper currency.
(5) The holder of the winning paper currency must scan a copy of the winning paper currency onto the YLAD redeeming form, (see, FIG. 2, page 13) and fill out the YLAD redeeming form. They must then download the YLAD-Predeeming form.
(6) A winner will claim their winnings in the same manner as described in claim I for YLAD redeeming form. (see steps 7-9, page 9, claim I)
